(19) United States
(12) Patent Application Publication
(10) Pub. No.: US 2011/0221841 A1
(43) Pub. Date: Sep. 15, 2011

(54) STRIPPING BLADE FOR STRIPPING MEDIA FROM A DRUM IN AN INKJET PRINTER

(75) Inventors: Kelvin Kwong, Tualatin, OR (US); Darryl I. Jensen, Woodburn, OR (US)

(73) Assignee: XEROX CORPORATION, Norwalk, CT (US)

(21) Appl. No.: 12/720,535

(22) Filed: Mar. 9, 2010

(51) Int. Cl. B41J 2/01; B65H 37/00

(52) U.S. Cl. 347/104; 83/145

(57) ABSTRACT

A stripper blade has been developed for high throughput inkjet printers. The stripper blade includes a metallic blade body having a first thickness that extends to a leading edge having a second thickness that is less than about 25% of the first thickness, and at least one beveled surface leading from the metallic blade body to the leading edge to form a stripping edge that facilitates separation of media from a drum.

### TECHNICAL FIELD

This disclosure relates generally to printers having a drum and, more particularly, to the components for facilitating removal of media from an offset imaging member after the media has passed through a transfix nip.

### BACKGROUND

In known printing systems having a drum, the print process includes an imaging phase, a transfix phase, and an overhead phase. In ink printing systems, the imaging phase is the portion of the print process in which the ink is expelled from the print head in an image pattern onto a transfer imaging surface or drum or other intermediate imaging member. The transfix phase is the portion of the print process in which the ink image is transferred from the drum to the recording medium. The image transfer typically occurs by bringing a transfix roller into contact with the imaging member to form a nip. The surface that is initially imaged may be referred to as a drum or receiving member and may be in the form of a drum, platen, band or the like. These surfaces may be referred to, for convenience, as an imaging drum, imaging member, or more simply, as a drum. The drum typically has a very thin release film on its surface that historically has been referred to as an intermediate transfer layer. This intermediate transfer layer receives the image and permits a more complete transfer of the image to media. A recording medium arrives at the nip as the drum rotates the image through the nip. The pressure in the nip helps transfer the image formed of malleable inks from the drum to the recording medium. As part of the overhead phase, the trailing edge of the recording medium passes out of the nip and the transfix roller is released from contacting the drum. The removal of the transfix member helps release the media from the drum. In some intermediate imaging printers, a stripper blade may be moved into position to intervene between the leading edge of a media leaving the transfix nip and the drum to facilitate separation of the media from the drum.

Inkjet printers that use drums, sometimes called offset printers, have been developed with higher throughput rates. Some of these printers have drum that have larger circumferences than previously known printers. The curvature of a larger drum and the speed of the drum in higher throughput printers reduce the window of time available for moving the stripper blade into position for separation of the media from the drum. As this window of time decreases, the time for the ink on the media to cool after passing through the transfix nip also decreases. Consequently, some portion of the malleable ink may transfer to the stripper blade. Accumulation of this ink on the stripper blade may interfere with the effectiveness of the stripper blade to lift media from the drum. The use of wider media also presents greater challenges in constructing a blade that is sufficiently straight and rigid to establish full strip edge contact across the length. Additionally, at higher rotational speeds the contact between a stripper blade and the drum has resulted in a greater likelihood of damage to the drum's surface. A system that separates media from a drum while preserving the quality of the ink image on each media sheet as well as the surface of the drum benefits the field of offset printing.

### SUMMARY

A stripper blade has been developed for high throughput inkjet printers. The stripper blade includes a metallic blade body having a first thickness that extends to a leading edge having a second thickness that is less than about 25% of the first thickness, and at least one beveled surface leading from the metallic blade body to the leading edge to form a stripping edge that facilitates separation of media from a drum.

A printer uses the stripper blade described above to facilitate the separation of media from the intermediate imaging member after the media exits a nip formed between the intermediate imaging member and a transfix roller. The printer includes a drum rotating past at least one printhead to receive ink ejected from the at least one printhead, a transfix roller configured to engage the drum selectively to form a nip through which media is transported to receive ink from the drum, and a stripper blade having metallic blade body with a first thickness that extends to a leading edge having a second thickness that is less than about 25% of the first thickness, at least one beveled surface leading from the metallic blade body to the leading edge, and the stripper blade being configured to engage the drum with the leading edge at a position near the nip formed between the transfix roller and the drum to facilitate separation of the media exiting the nip from the drum.

### BRIEF DESCRIPTION OF THE DRAWINGS

The foregoing aspects and other features of an ink printer implementing a stripper blade system are explained in the following description, taken in connection with the accompanying drawings, wherein:

FIG. 1A is a cross-sectional view of a metallic stripper blade.

FIG. 1B is a cross-sectional view depicting the leading edge of the stripper blade of FIG. 1A.

FIG. 1C is a perspective view depicting the metallic stripper blade of FIG. 1A.

FIG. 1D is a perspective view depicting an alternative stripper blade.

FIG. 2. is a side view of a stripper blade stripping a media sheet from a drum.

FIG. 3 is a side view of a prior art ink printer.

### DETAILED DESCRIPTION

Referring to FIG. 3, there is shown a side view of a prior art ink printer 10 that may be modified to include a stripper blade system that reduces undesirable ink transfer during the printing process. The reader should understand that the embodiment of the print process discussed below may be implemented in many alternate forms and variations. In addition, any suitable size, shape or type of elements or materials may be used.

As shown in FIG. 3, the ink printer 10 may include an ink loader 40, an electronics module 44, a paper/media tray 48, a print head 50, a drum 52, a drum maintenance subsystem 54, a transfix subsystem 58, a wiper subassembly 60, a paper/media preheater 64, a duplex print path 68, and an ink waste tray 70. In brief, solid ink sticks are loaded into ink loader 40 through which they travel to a melt plate (not shown). At the melt plate, the ink stick is melted and the liquid ink is diverted to a reservoir in the print head 50. The ink is ejected by piezoelectric elements to form an image on the drum 52 as the member rotates. Member 52 is called a drum because an ink image is formed on the rotating member and then transferred to media with the transfix subsystem.

A drum heater is controlled by a controller to maintain the drum within an optimal temperature range for generating an ink image and transferring it to a sheet of recording media. A sheet of recording media is removed from the paper/media tray 48 and directed into the paper pre-heater 64 so the sheet of recording media is heated to a more optimal temperature for receiving the ink image. The sheet of recording media is synchronized so its movement between the transfix roller in the transfer subsystem 58 and the intermediate image member or drum 52 is coordinated for the transfer of the image from the imaging member to the sheet of recording media.

The operations of the ink printer 10 are controlled by the electronics module 44. The electronics module 44 includes a power supply 80, a main board 84 with a controller, memory, and interface components (not shown), a hard drive 88, a power control board 90, and a configuration card 94. The power supply 80 generates various power levels for the various components and subsystems of the ink printer 10. The power control board 90 regulates these power levels. The configuration card contains data in nonvolatile memory that defines the various operating parameters and configurations for the components and subsystems of the ink printer 10. The hard drive stores data used for operating the ink printer and software modules that may be loaded and executed in the memory on the main card 84. The main board 84 includes the controller that operates the ink printer 10 is configured in accordance with an operating program executing in the memory of the main board 84. The controller receives signals from the various components and subsystems of the ink printer 10 through interface components on the main board 84. The controller also generates control signals that are delivered to the components and subsystems through the interface components. These control signals, for example, drive the piezoelectric elements to expel ink from the print heads to form the image on the imaging member 52 as the member rotates past the print head. The printer depicted in FIG. 3 is merely exemplary of a printer suitable for adaptation with a stripper blade system, and the stripper blade system described herein may be used in a variety of printers with alternative components and configurations.

The actuator 128 and transfix roller actuator 156 are both configured to operate in response to signals received from a controller (not shown). The controller may be a general purpose microprocessor that executes programmed instructions that are stored in a memory. The controller also includes the interface and input/output (I/O) components for receiving status signals from the printer and supplying control signals to the printer components. Alternatively, the controller may be a dedicated processor on a substrate with the necessary memory, interface, and I/O components also provided on the substrate. Such devices are sometimes known as application specific integrated circuits (ASIC). The controller may also be implemented with appropriately configured discrete electronic components or primarily as a computer program or as a combination of appropriately configured hardware and software components.

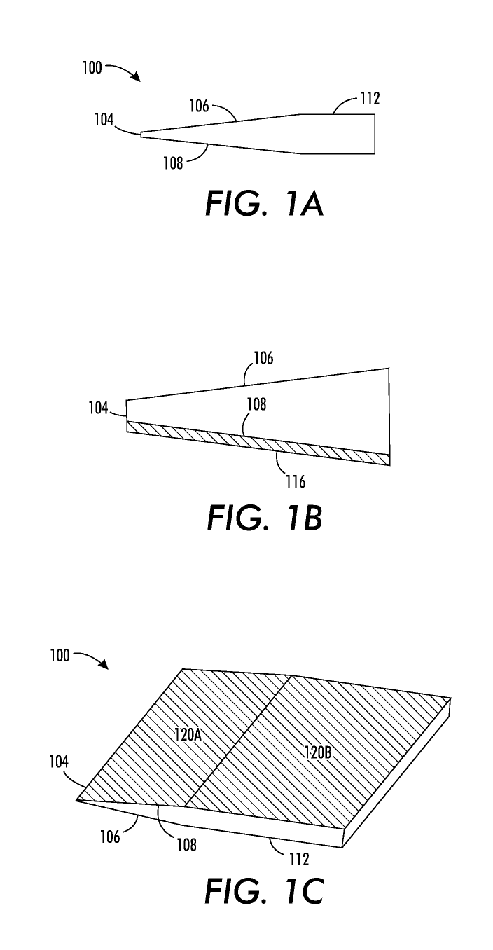

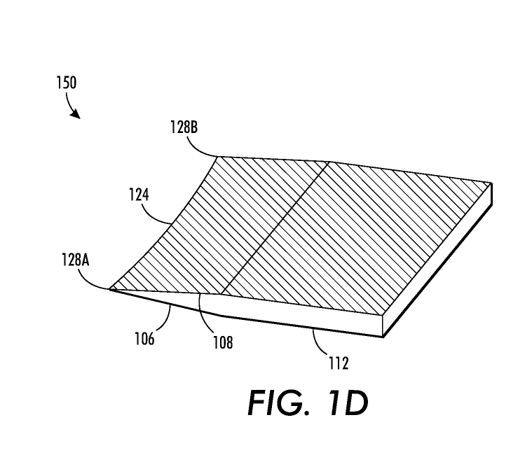

A cross sectional view of a stripper blade that may be used to strip media away from an imaging member is depicted in FIG. 1A. The stripper blade 100 has a body portion 112 with a substantially uniform thickness. In the embodiment of FIG. 1A the central portion 112 is approximately 0.4 mm thick. The stripper blade 100 has two beveled edges 106 and 108 that extend from the body portion 112 to an edge 104. In the example of FIG. 1A, edge 104 is approximately 0.02 mm thick, and the beveled edges 106 and 108 are each beveled at a 7° angle from horizontal. The upper and lower beveled edges 106 and 108 each have a length of approximately 1.63 mm. The upper beveled edge 106 comes into contact with the drum when the stripper blade 100 is placed in contact with the drum. One embodiment of a stripper blade implementation has been described, however, the blade may be configured with a one sided bevel or compound bevels on one or both sides and any bevel may be any angle. Drum width and diameter as well as other influences, such as media type, speed, ink formulation and the like may influence optimal blade geometry. In the implementation described, the beveled blade edge converges to a sharp edge with thickness of 0.03 mm or less, including a razor sharp thickness that is essentially zero. Anti-friction coating or plating may add to this thickness. The stripper blade 100 is composed of a metal or metallic alloy, such as steel, tempered steel, or stainless steel.

A detailed view of the leading edge of stripper blade 100 is depicted in FIG. 1B. An optional low-friction coating 116 covers the lower beveled edge 108. The low friction coating 116 lubricates the area of contact between the stripper blade 100 and a media sheet that is being separated from the drum, facilitating a smooth separation of the media sheet. The low friction coating 116 also resists the transfer of ink from the media sheet to the stripper blade 100. The low friction coating 116 is typically composed of a polymer, such as polysaccharide, polytetrafluoroethylene, or silicone. The coating may be applied to the surface of beveled edge 108, or bonded into the beveled edge 108 using an oxidation infusion process known to the art. In an alternative blade arrangement where the upper beveled edge 106 contacts media sheets instead of the lower beveled edge 116, the low friction coating 116 would instead be applied to the upper beveled edge 106.

A surface of the stripper blade from FIG. 1A is depicted in FIG. 1C. In FIG. 1C, the stripper blade 100 has a leading edge 104 that may have a width of approximately 320 mm, which is approximately equal to the width of drums in many tabloid size inkjet printers. Alternative widths are envisioned depending upon the width of the drum and the print media handled by a printer using stripper blade 100. The beveled edges 108 and 106 form sloped surfaces with surface 120A depicted in FIG. 1C. The surface 120A is covered by the low friction coating material discussed above. The body portion 112 of the stripper blade 100 extends from the beveled edges 106 and 108, and in the embodiment of FIG. 1C, the surface 120B of the central portion 112 is also covered with the low-friction coating material. The low-friction coating material covers both surfaces 120A and 120B to facilitate separation of a media sheet over the entire surface of the stripper blade 100. The leading or stripper edge that is functional for stripping media bearing a transfixed image from the surface initially imaged is at least as long as the largest media size to be accommodated, plus appropriate system tolerances. End treatment beyond this stripping edge may be modified to prevent the ends of the sharp stripping edge from scaring or digging into the drum, image or media. This end treatment includes rounding, chamfering, or forming the ends of the stripping edge so the ends do not substantially contact the drum. Consequently, the sharp stripping edge that facilitates the separation of the media from the drum may be all or a substantial portion of the blade length. Blade length as used in this document refers to the distance between the ends of the stripper blade at the stripping edge.

An alternative embodiment of a stripper blade is depicted in FIG. 1D. The stripper blade 150 in FIG. 1D has a curved leading edge 124. The curved leading edge 124 curves or bows downwardly, allowing the outboard blade ends 128A and 128B to engage a drum before the central portion of leading edge 124. This configuration allows for a more uniform distribution of pressure between the stripper blade 150 and a drum than the embodiments have a straight leading edge. When the stripping edge of the blade 150 is held flat, as with force against a drum, a blade fabricated with the intentional bow forms a straight stripping edge.

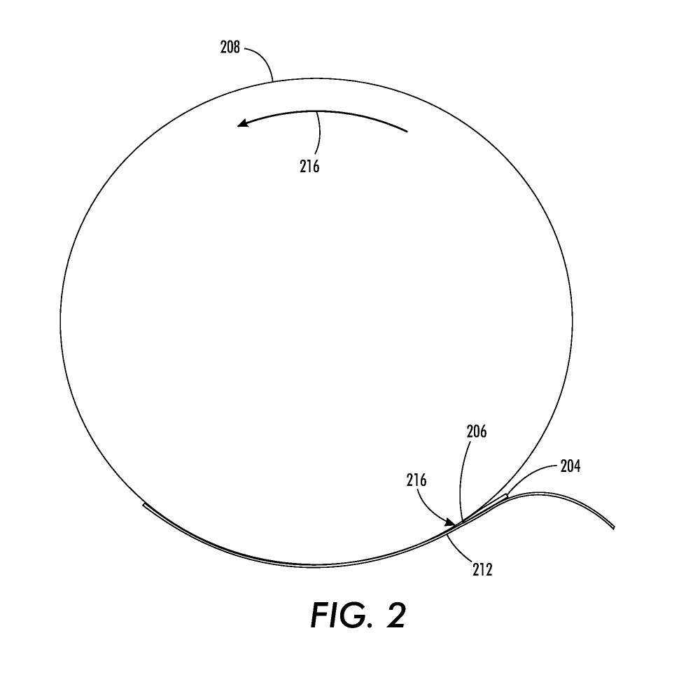

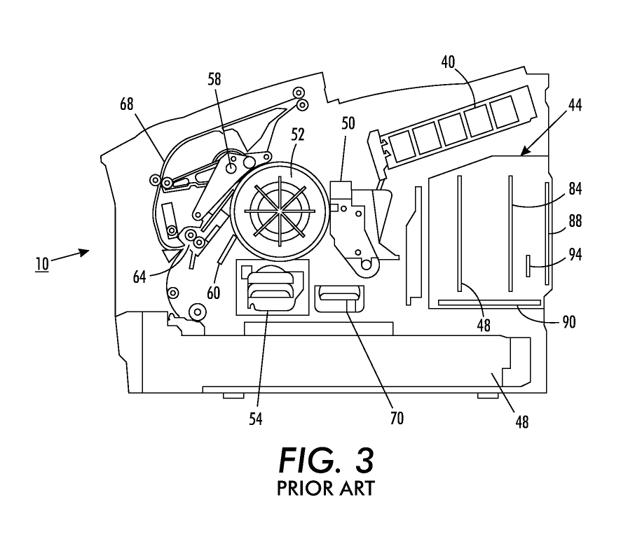

A stripper blade stripping a media sheet from a drum is depicted in FIG. 2. The drum, depicted in FIG. 2 as a rotating drum 208, rotates in direction 216 carrying media sheet 212. Stripper blade 204 engages the surface of drum 208, and the media sheet 212 separates from the drum 208 as it moves over the stripper blade 204, beginning at the blade-drum intersection 216. The stripper blade 204 is arranged with the beveled leading edge 206 opposing the rotational direction 216 of drum 208. The beveled leading edge 206 begins to lift the media sheet 212 from the drum 208, and the media sheet continues lifting away from the drum 208 as it passes over stripper blade 204. A low-friction coating may be applied to the surface of stripper blade 204 that contacts the media sheet 212, reducing the likelihood of the media sheet 212 stubbing on contact with the stripper blade 204.

In operation, ink is ejected from at least one print head onto the surface of the drum, forming a latent image. The transfix roller is moved into a transfix nip position with the drum, and the drum rotates, carrying a media sheet through the transfix nip to transfer the latent image from the drum to the media sheet. The stripper blade is placed against the surface of the drum at a position ahead of the leading edge of the media sheet after the leading edge of the media sheet emerges from the transfix nip. At least a portion of the media sheet surface that was in contact with the drum contacts the stripper blade as the media sheet separates from the drum. The portion of the media sheet contacting the stripper blade contacts the stripper blade's low-friction coating. The stripper blade is removed from contact with the drum after the media sheet has separated from the drum. The transfix roller is removed from the transfix nip after the media sheet has passed through the transfix nip. The process recited above may be repeated for multiple media sheets in a printer and may vary to some extent as to phasing or timing of the process.

It will be appreciated that various of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

We claim:

1. A stripper blade comprising:
a metallic blade body having a first thickness that extends to a leading edge having a second thickness that is less than about 25% of the first thickness; and
at least one beveled surface leading from the metallic blade body to the leading edge to form a stripping edge that facilitates separation of media from a drum.

2. The stripper blade of claim 1 wherein the metallic blade body is substantially comprised of stainless steel.

3. The stripper blade of claim 2 wherein the at least one beveled surface leading from the metallic blade slopes at an angle of no more than about seven degrees from a surface of the metallic blade body.

4. The stripper blade of claim 1 wherein the metallic blade has a width that is approximately equal to a width of a drum in a printer.

5. The stripper blade of claim 4 wherein the leading edge of the metallic blade has a bow along the leading edge that enables outboard ends of the leading edge to contact the drum before a central portion of the leading edge.

6. The stripper blade of claim 1 wherein the leading edge of the metallic blade has a thickness that is less than 0.1 millimeters.

7. The stripper blade of claim 1 wherein the leading edge of the metallic blade has a thickness that is less than 0.03 millimeters.

8. The stripper blade of claim 1 further comprising:
a low friction coating on at least one surface along the leading edge.

9. The stripper blade of claim 1 further comprising:
a low friction coating on the at least one beveled surface and a non-beveled surface.

10. The stripper blade of claim 9 wherein the low friction coating is substantially comprised of one of polysaccharide, polytetrafluoroethylene, or silicone.

11. The stripper blade of claim 9 wherein the low friction coating is an oxidation infusion essentially consisting of one of polysaccharide, polytetrafluoroethylene, or silicone.

12. A printer comprising:
a drum rotating past at least one printhead to receive ink ejected from the at least one printhead;
a transfix roller configured to engage the drum selectively to form a nip through which media is transported to receive ink from the drum; and
a stripper blade having metallic blade body with a first thickness that extends to a leading edge having a second thickness that is less than about 25% of the first thickness, at least one beveled surface leading from the metallic blade body to the leading edge, and the stripper blade being configured to engage the drum with the leading edge at a position near the nip formed between the transfix roller and the drum to facilitate separation of the media exiting the nip from the drum.

13. The printer of claim 12 wherein the metallic blade body of the stripper blade is substantially comprised of stainless steel.

14. The printer of claim 13 wherein the at least one beveled surface of the stripper blade slopes at an angle of no more than about seven degrees from a surface of the metallic blade body to the leading edge of the stripper blade.

15. The printer of claim 12 wherein the metallic blade body has a width that is approximately equal to a width of the bow in the printer.

16. The printer of claim 15 wherein the leading edge of the metallic blade body has a bow along the leading edge that enables outboard ends of the leading edge to contact the drum before a central portion of the leading edge.

17. The printer of claim 12 wherein the leading edge of the metallic blade has a thickness that is less than 0.03 millimeters.

18. The printer of claim 12 further comprising:
a low friction coating on at least one surface of the leading edge of the stripper blade.

19. The printer of claim 18 wherein the low friction coating is substantially comprised of one of polysaccharide, polytetrafluoroethylene, or silicone.

20. The printer of claim 18 wherein the low friction coating is an oxidation infusion substantially comprised of one of polysaccharide, polytetrafluoroethylene, or silicone.
